(19) United States
(12) Patent Application Publication
(10) Pub. No.: US 2020/0366110 A1
(43) Pub. Date: Nov. 19, 2020

(54) POWER AND LIGHTING MECHANISM

(71) Applicant: Oxti Corporation, Taipei (TW)

(72) Inventor: Chih Feng Ho, Taipei (TW)

(21) Appl. No.: 16/413,711

(22) Filed: May 16, 2019

(51) Int. Cl. H02J 7/00; F21V 23/02; H02J 7/02; H01R 13/22

(52) U.S. Cl. CPC H02J 7/0045; F21V 23/02; H01R 13/22; H02J 7/0013; H02J 7/025

(57) ABSTRACT

A power and lighting mechanism includes a receptacle having an input terminal and one or more output terminals, a light element, a battery disposed in the receptacle and connected to the output terminal and the input terminal of the receptacle, a housing engaged into the receptacle and extendible out of the receptacle at an outer working position, and one or more electric charging and storing members disposed in the housing and electrically connected to the battery, The housing includes a key engaged with a track of the receptacle and engageable with a seat of the receptacle for supporting the housing out of the receptacle at an outer working position.

### BACKGROUND OF THE INVENTION

### 1. Field of the Invention

The present invention relates to a portable converter hub or electric power source or power and lighting mechanism, and more particularly to a portable electric power source or power and lighting mechanism including an improved compact structure or configuration for being easily carried with the user and for being easily actuated or operated by the user.

### 2. Description of the Prior Art

Typical converter hub assemblies or electric power source or and lighting mechanisms comprise a container or housing or receptacle including a chamber or compartment formed therein for receiving or storing various electric circuit boards or parts or elements therein, and including a number of ports or terminals or connectors for electrically connecting or coupling to various electrical facilities or implements.

For example, U.S. Pat. No. 8,203,237 B1 to Cowles, U.S. Pat. No. 9,237,217 B2 to Zeung et al., U.S. Pat. No. 9,490,659 B1 to English et al., U.S. Pat. No. 9,543,770 to O'Keefe et al., U.S. Pat. No. 9,864,421 B2 to Li et al., and U.S. Pat. No. 9,997,939 B2 to Li disclose several of the typical converter hubs or electric power source or power and lighting mechanisms each comprising a container having one or more ports or terminals or connectors for electrically connecting or coupling to various electrical facilities or implements.

However, the typical converter hubs or electric power source or power and lighting mechanisms may not be easily carried with the user and also may not be easily used and actuated or operated by the user.

The present invention has arisen to mitigate and/or obviate the afore-described disadvantages of the conventional converter hubs or electric power sources or and lighting mechanisms.

### SUMMARY OF THE INVENTION

The primary objective of the present invention is to provide a portable electric power source or facility or power and lighting mechanism including an improved compact structure or configuration for being easily carried with the user and for being easily actuated or operated by the user.

In accordance with one aspect of the invention, there is provided a power and lighting mechanism comprising a receptacle including an input terminal, and at least one output terminal, a light element formed or provided in the receptacle, a battery disposed in the receptacle and electrically connected to the input terminal of the receptacle, the battery is electrically connected to the output terminal and electrically connected to the light element for energizing the light element, an electric cable for electrically connecting to the input terminal of the receptacle and for receiving the electric power or energy from the vehicles or the house families, a housing slidably engaged into the receptacle, and receivable within the receptacle, and the housing is extendible out of the receptacle at an outer working position, and at least one electric charging and storing member disposed in the housing and electrically connected to the battery for supplying the electric power or energy to the battery.

The housing includes a connector engaged in the housing and electrically connected to the battery, and the electric charging and storing member includes a coupler for engaging with the connector of the housing and for allowing the electric charging and storing member to supply the electric power or energy to the battery. The housing includes a recess formed therein for receiving and engaging with the electric charging and storing member and for stably anchoring and retaining the electric charging and storing member in the housing.

The housing includes a handle for being grasped and held by a user and for allowing the receptacle and the housing to be carried elesewhere. The housing includes a partition formed and provided therein for separating an inner portion of the housing into two compartments. The receptacle includes an AC/DC convertor electrically connected to the battery and electrically connected to the input terminal selectively.

The receptacle includes a track formed and provided in the receptacle for slidably engaging with the housing. The housing includes a key slidably engaged with the track of the receptacle for guiding and limiting the housing to engage into the receptacle. The track of the receptacle includes a first seat and second seat, the key of the housing is engageable with the first seat of the track for supporting the housing out of the receptacle at an outer working position, and engageable with the second seat of the track for supporting and anchoring the housing to the receptacle in an inner storing position.

The receptacle includes two contacts, and the housing includes a conductor for engaging with the contacts of the receptacle for connecting the contacts of the receptacle together selectively. A wireless charging mechanism may further be provided and electrically connected to the battery for supplying the electric power or energy to the battery selectively and wirelessly.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view illustrating the operation of a power and lighting mechanism in accordance with the present invention;

FIG. 2 is a perspective view of the power and lighting mechanism, as seen from the front portion of the power and lighting mechanism;

FIG. 3 is another perspective view similar to FIG. 2, illustrating the operation of the power and lighting mechanism;

FIG. 4 is a plan schematic view of the power and lighting mechanism;

FIG. 5 is another plan schematic view similar to FIG. 4, illustrating the operation of the power and lighting mechanism;

FIG. 6 is a block diagram of the power and lighting mechanism;

FIG. 7 is another block diagram of the power and lighting mechanism;

FIGS. 8, 9 are plan schematic views illustrating the electric circuit of the power and lighting mechanism; and

FIG. 10 is another perspective view illustrating the operation of the power and lighting mechanism.

### DETAILED DESCRIPTION OF THE PREFERRED EMBODIMENT

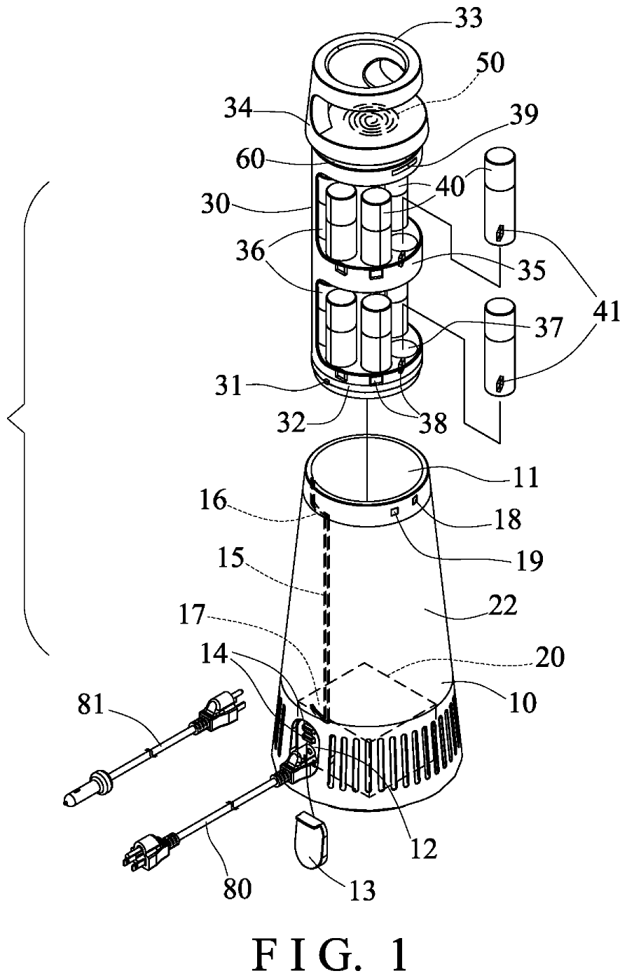

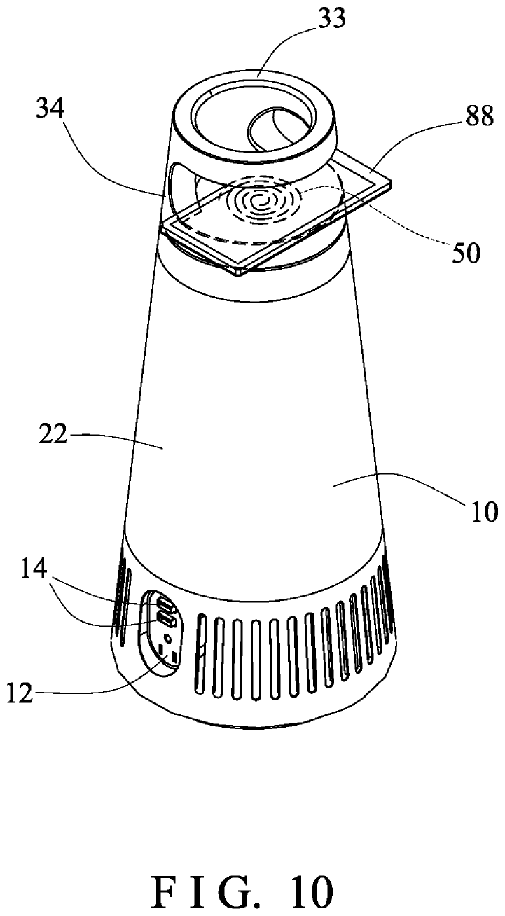

Referring to the drawings, and initially to FIGS. 1-5, an electric power source or facility or portable power and lighting mechanism in accordance with the present invention comprises an outer container or receptacle 10 including a substantially truncated cone or frustum shaped structure or configuration, and including a compartment or chamber 11 formed therein for receiving various parts or elements therein, and including a front and lower portion having an input socket or terminal 12 (FIGS. 1, 10) formed or provided therein for electrically connecting or coupling to various electrical facilities or implements or power suppliers, for example, the input terminal 12 may be electrically connected or coupled to an indoor electric power source or reservoir (not illustrated) with an indoor electric cable 80 (FIG. 1), for receiving or obtaining the electric power or energy from the indoor electric power reservoir or the like selectively, and may also be electrically connected or coupled to the vehicle power source (not illustrated) with a vehicle electric cable 81, for receiving or obtaining the electric power from the vehicle power reservoir or the like selectively.

The receptacle 10 includes a cap or lid 13 (FIGS. 1-3) attached or engaged onto the front and lower portion of the receptacle 10 for covering or shielding the input terminal 12 and the like, and for preventing the dirt or containment from entering into the input terminal 12. The receptacle 10 further includes one or more (such as two) connecting members or output terminals 14 formed or provided in the front and lower portion thereof and arranged or located close to or beside the input terminal 12, and arranged to be covered and shielded by the lid 13. The receptacle 10 further includes a groove or track 15 formed or provided therein and communicating with the chamber 11 of the receptacle 10, and the track 15 includes an upper or first seat 16 and a lower or second seat 17 formed or provided therein. The receptacle 10 further includes one or more (such as two) conductors or contacts 18, 19 formed or provided therein, such as formed in the upper portion thereof.

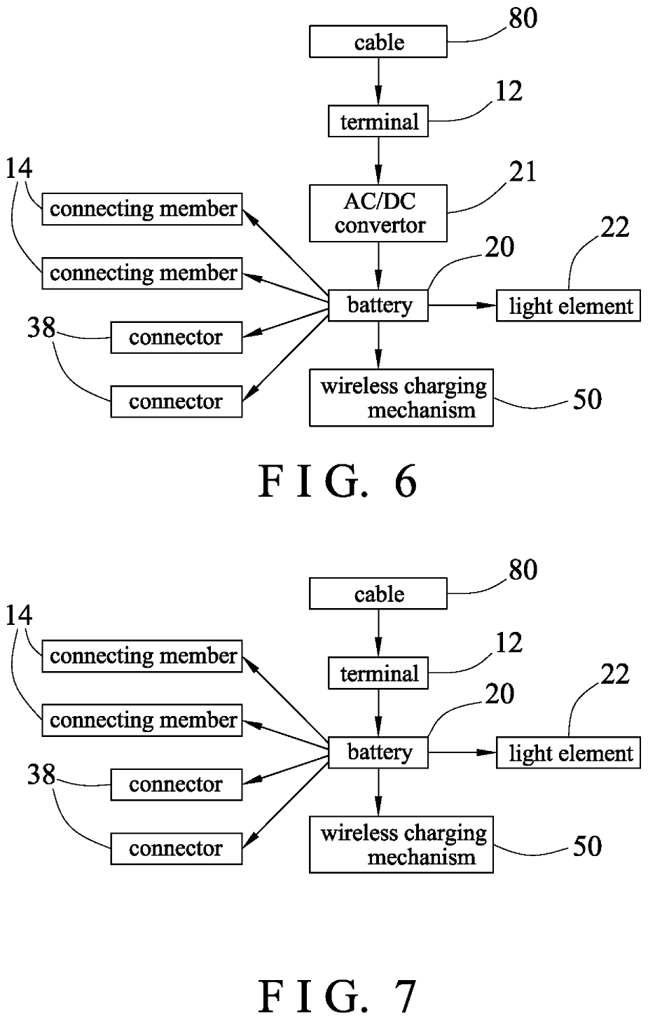

An electric power source or reservoir or battery 20 (FIG. 1) is disposed or engaged in the chamber 11 of the receptacle 10, and an alternate current (AC) and direct current (DC) convertor 21 (FIG. 6) is electrically connected or coupled to the battery 20 and also electrically connected or coupled to the input terminal 12 of the receptacle 10 which may be selectively engaged with or connected or coupled to the indoor electric cable 80 for receiving or obtaining the electric power or energy from the indoor electric power reservoir or the like selectively, and/or as shown in FIG. 7, the battery 20 may also be directly and electrically connected or coupled to the input terminal 12 of the receptacle 10 which may be selectively engaged with or connected or coupled to the vehicle electric cable 81 for receiving or obtaining the electric power or energy from the vehicle power reservoir or the like selectively. The output terminals 14 are electrically connected or coupled to the battery 20 (FIGS. 6, 7).

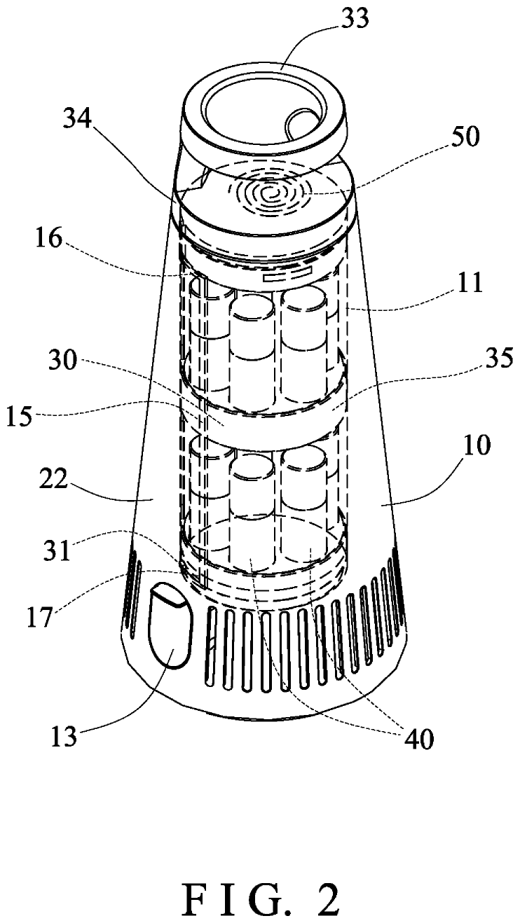

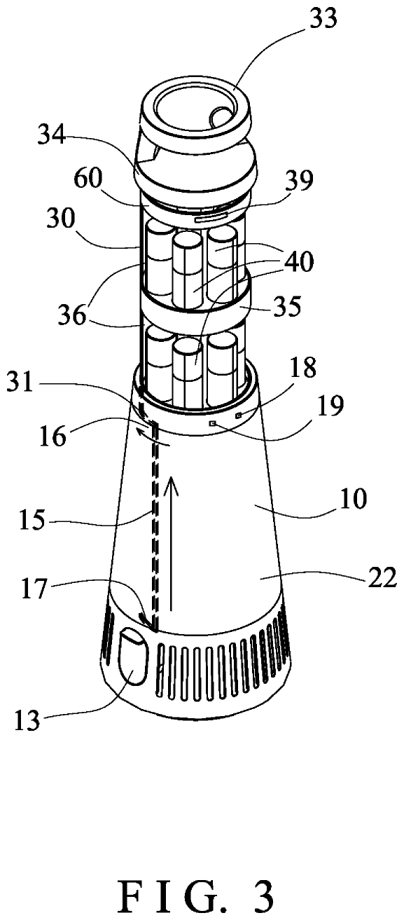

The portable power and lighting mechanism further comprises an inner container or housing 30 engageable into the chamber 11 of the receptacle 10, and receivable or containable within the chamber 11 of the receptacle 10 (FIGS. 2 and 4-5), and the housing 30 includes a projection or key 31 extended outwardly therefrom, such as extended outwardly from the lower or base portion 32 thereof and slidably engageable with the track 15 of the receptacle 10 for guiding and limiting the housing 30 to engage into the chamber 11 of the receptacle 10, and the key 31 of the housing 30 is engageable with the upper or first seat 16 of the track 15 (FIG. 3) for selectively supporting the housing 30 out of the receptacle 10 and at an upper and outer working position. The key 31 of the housing 30 may also be engaged with the lower or second seat 17 of the track 15 (FIG. 2) selectively for anchoring or retaining and locking the housing 30 to the receptacle 10 in an inner receiving or storing position and for preventing the housing 30 from being disengaged or separated from the receptacle 10 inadvertently.

The housing 30 further includes a handles 33 formed or provided thereon, such as formed on the upper portion 34 thereof for being grasped and held by the user and for selectively engaging the housing 30 into and out of the receptacle 10. The housing 30 further includes one or more plates or partitions 35 formed or provided therein for separating the inner portion of the housing 30 into one or more (such as two) chambers or compartments 36. The housing 30 further includes one or more socket openings or recesses 37 formed in the partition 35 and/or the base portion 32 of the housing 30 for receiving or engaging with charging and storing members 40 therein. The housing 30 further includes a terminal or connector 38 (FIG. 1) disposed or engaged in each of the recesses 37 of the housing 30, and the charging and storing members 40 each include a terminal or coupler 41 (FIG. 1) formed or provided therein for selectively and electrically engaging with the connector 38 of the housing 30.

As shown in FIG. 6, illustrated us a block diagram of the power and lighting mechanism in accordance with the present invention, in which the output terminals 14 of the receptacle 10 and the connector 38 of the housing 30 are electrically connected or coupled to the battery 20, and the couplers 41 of the charging and storing members 40 are electrically connected or coupled to the connector 38 of the housing 30 for allowing the charging and storing members 40 to supply the electric power or energy to the battery 20 selectively. The indoor electric power reservoir and/or the vehicle power reservoir or the like may also supply the electric power or energy to the battery 20 selectively. As shown in FIGS. 1-2 and 6-7, a wireless charging mechanism 50 may further be provided and disposed or engaged in or attached to the housing 30, and electrically connected or coupled to the battery 20 for further supplying the electric power or energy to the battery 20 selectively and wirelessly.

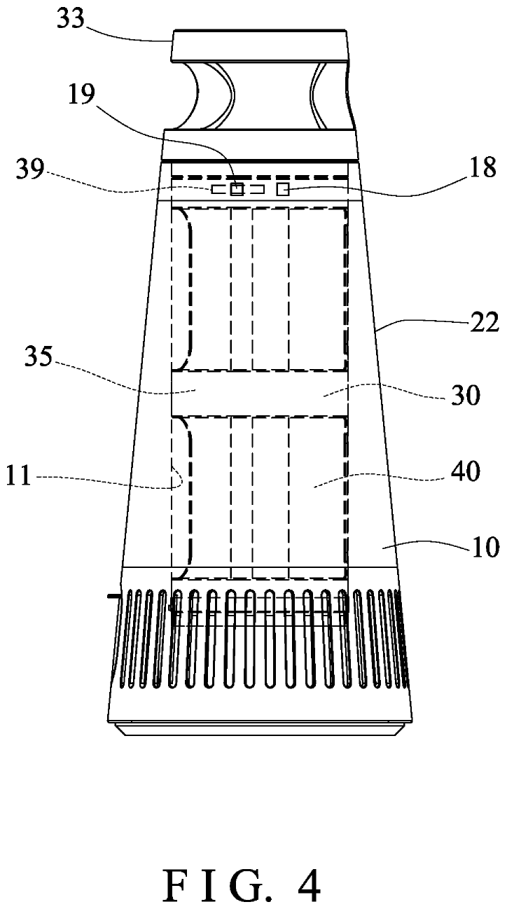

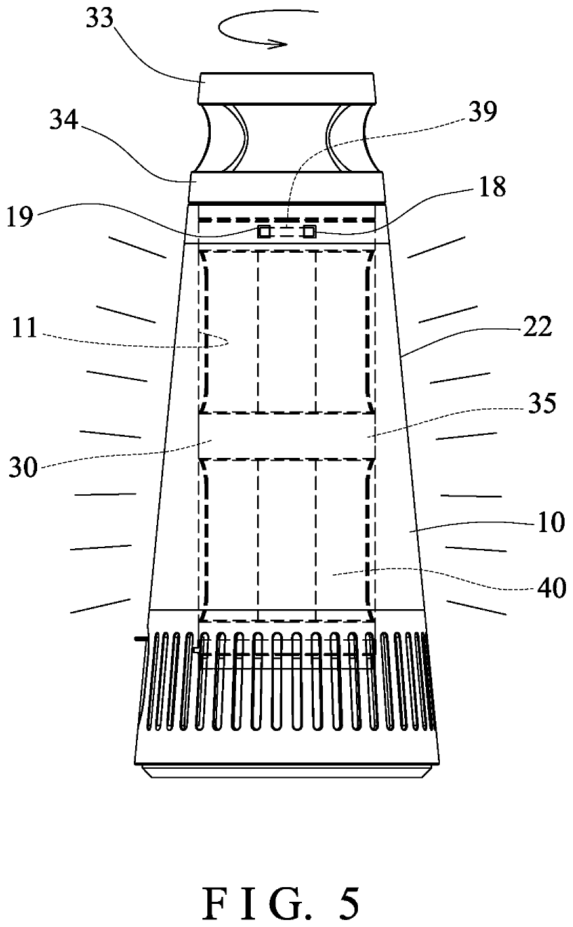

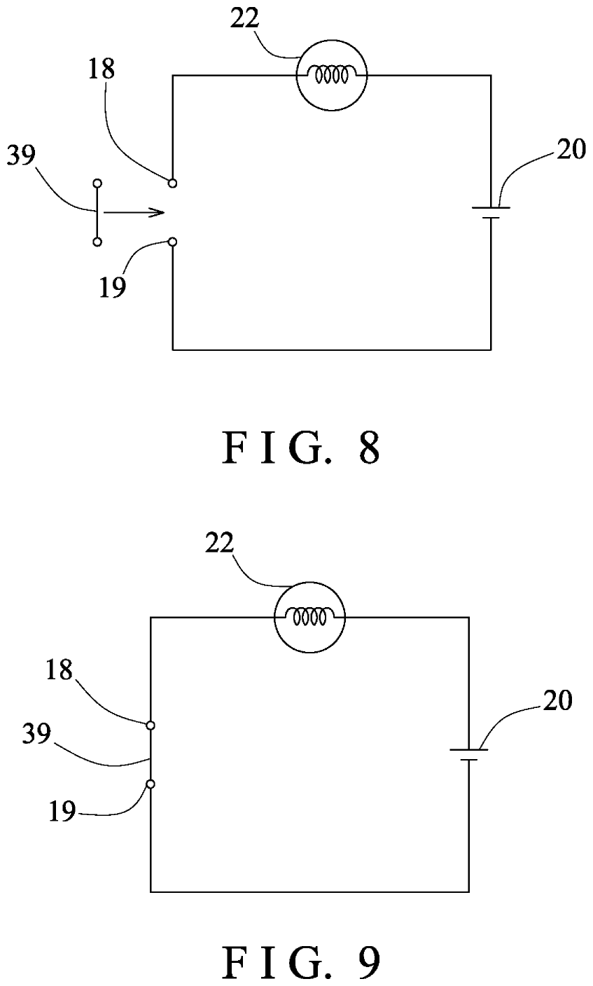

The receptacle 10 further includes a light device or light element 22 disposed or engaged in or attached to the receptacle 10 and electrically connected or coupled to the battery 20 for receiving or obtaining the electric power or energy from the battery 20 and for being energized by the battery 20 selectively. The housing 30 further includes a contact or conductor 39 formed or provided therein (FIGS. 1, 4-5, 8-9) for selectively engaging with the contacts 18, 19 of the receptacle 10. For example, as shown in FIGS. 5 and 9, when the housing 30 is engaged into the receptacle 10, it is preferable that the conductor 39 of the housing 30 is engaged with or connected or coupled to the contacts 18, 19 of the receptacle 10 for selectively connecting or coupling the contacts 18, 19 of the receptacle 10 together and for allowing the light element 22 to be energized or actuated or operated selectively. On the contrary, as shown in FIGS. 4 and 8, when the housing 30 is pivoted or rotated relative to the receptacle 10, the conductor 39 may be disengaged or separated from one of the contacts 18, 19 of the receptacle 10, such that the contacts 18, 19 of the receptacle 10 are not electrically connected or coupled together and such that the light element 22 may not be energized or actuated or operated. At this moment, the key 31 of the housing 30 may be engaged with the lower or second seat 17 of the track 15 (FIG. 2) for anchoring or retaining and locking the housing 30 to the receptacle 10 selectively.

As shown in FIGS. 1 and 3, the housing 30 may further include a cold light member 60 which may be electrically connected or coupled to the battery 20 for receiving or obtaining the electric power or energy from the battery 20 and for being energized to generate a cold light or the like, or alternatively, the cold light member 60 may also be energized by the other batteries (not illustrated) or the like for being energized to generate the cold light without the battery 20. The output terminals 14 of the receptacle 10 may be provided for outputting the electric power or energy or the like to various electrical facilities or implements or the like.

In operation, as shown in FIGS. 2 and 3, the key 31 of the housing 30 may be engaged with the upper or first seat 16 of the track 15 for selectively supporting the housing 30 out of the receptacle 10 at the upper and outer working position (FIG. 3), and the key 31 of the housing 30 may also be engaged with the lower or second seat 17 of the track 15 for anchoring or retaining and locking the housing 30 to the receptacle 10 selectively (FIG. 2). The cold light member 60 may be used for being energized to generate the cold light and for allowing the receptacle 10 and the housing 30 of the power and lighting mechanism to be easily seen and found by the users. As shown in FIGS. 1 and 6-7, the input terminal 12 of the receptacle 10 may be electrically connected or coupled to the indoor electric power source with the indoor electric cable 80, or may be electrically connected or coupled to the vehicle power source with the vehicle electric cable 81, for receiving or obtaining the electric power from the vehicle power reservoir or the like selectively, and for supplying the electric power or energy to the battery 20 selectively.

The output terminals 14 of the receptacle 10 may be provided for outputting the electric power or energy or the like to various electrical facilities or implements or the like, it is to be noted that, typically, the electrical facilities or implements or the like may not be easily and quickly and readily and electrically connected or coupled to the indoor electric power source or reservoir and/or the vehicle power reservoir. With the power and lighting mechanism in accordance with the present invention, the various electrical facilities or implements or the like may be easily and quickly and readily and electrically connected or coupled to the indoor electric power source or reservoir and/or the vehicle power reservoir with or through the battery 20. As shown in FIG. 10, the wireless charging mechanism 5 may also be provided and used for charging various electrical facilities or implements or the like, such as the portable or mobile phone 88, the I-pad or the like.

Accordingly, the portable power and lighting mechanism in accordance with the present invention includes an improved compact structure or configuration for being easily carried with the user and for being easily actuated or operated by the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A power and lighting mechanism comprising:
a receptacle including an input terminal, and at least one output terminal,
a light element,
a battery disposed in said receptacle and electrically connected to said input terminal of said receptacle, said battery being electrically connected to said at least one output terminal and electrically connected to said light element,
an electric cable for electrically connecting to said input terminal of said receptacle,
a housing slidably engaged into said receptacle, and receivable within said receptacle, and extendible out of said receptacle at an outer working position, and
at least one electric charging and storing member disposed in said housing and electrically connected to said battery.

2. The power and lighting mechanism as claimed in claim 1, wherein said housing includes a connector engaged in said housing and electrically connected to said battery, and said at least one electric charging and storing member includes a coupler for engaging with said connector of said housing.

3. The power and lighting mechanism as claimed in claim 2, wherein said housing includes a recess formed therein for receiving and engaging with said at least one electric charging and storing member.

4. The power and lighting mechanism as claimed in claim 1, wherein said housing includes a handle for being grasped and held by a user.

5. The power and lighting mechanism as claimed in claim 1, wherein said housing includes a partition formed and provided therein for separating an inner portion of said housing into two compartments.

6. The power and lighting mechanism as claimed in claim 1, wherein said receptacle includes an AC/DC convertor electrically connected to said battery and electrically connected to said input terminal.

7. The power and lighting mechanism as claimed in claim 1, wherein said receptacle includes a track formed and provided in said receptacle for slidably engaging with said housing.

8. The power and lighting mechanism as claimed in claim 7, wherein said housing includes a key slidably engaged with said track of said receptacle for guiding and limiting said housing to engage into said receptacle.

9. The power and lighting mechanism as claimed in claim 8, wherein said track of said receptacle includes a first seat and second seat, said key of said housing is engageable with said first seat of said track for supporting said housing out of said receptacle at an outer working position, and engageable with said second seat of said track for anchoring said housing to said receptacle in an inner storing position.

10. The power and lighting mechanism as claimed in claim 1, wherein said receptacle includes two contacts, and said housing includes a conductor for engaging with said contacts of said receptacle for connecting said contacts of said receptacle together selectively.

11. The power and lighting mechanism as claimed in claim 1 further comprising a wireless charging mechanism electrically connected to said battery.
